(19) United States
(12) Patent Application Publication
(10) Pub. No.: US 2026/0287873 A1
(43) Pub. Date: Sep. 24, 2026

(54) OPTICAL MICROSCOPE AND PERFORMANCE DETERMINATION METHOD

(71) Applicant: Evident Corporation, Tatsuno-machi (JP)

(72) Inventors: Hirokazu KUBO, Kamiina-gun (JP); Yasuo YONEMARU, Kamiina-gun (JP); Daiki HORIBA, Kamiina-gun (JP)

(73) Assignee: Evident Corporation, Tatsuno-machi (JP)

(21) Appl. No.: 19/687,443

(22) Filed: May 26, 2026

Related U.S. Application Data
(63) Continuation of application No. PCT/JP2024/040834, filed on Nov. 18, 2024.

(30) Foreign Application Priority Data
Dec. 1, 2023 (JP) 2023-203892

(51) Int. Cl. G02B 21/00; G02B 21/04; G02B 21/08; G02B 21/36

(52) U.S. Cl. CPC G02B 21/0076; G02B 21/04; G02B 21/08; G02B 21/365

(57) ABSTRACT

An objective lens, a light source configured to output excitation light, an excitation output measurement device configured to measure an excitation output, and a processor configured to measure imaging performance and determine performance of an optical microscope on the basis of a measurement result of the imaging performance and a measurement result of the excitation output are provided.

### CROSS-REFERENCE TO RELATED APPLICATIONS

This application is a continuation application of PCT/JP2024/040834, filed Nov. 18, 2024, which claims the benefit of Japanese Patent Application No. 2023-203892, filed Dec. 1, 2023, the entire contents of both of which are incorporated herein by this reference.

### FIELD

The disclosure of the present specification relates to an optical microscope and a performance determination method.

### BACKGROUND

An image acquired by an optical microscope is mainly used for observing a shape, but is also increasingly used for quantitative analysis. In recent years, with the progress of computer analysis technology such as artificial intelligence (AI), use of image data for omics analysis and the like has progressed. Therefore, the quantitativity of data used for analysis is important.

In a fluorescence microscope, data is quantified by measuring an excitation light source intensity (excitation output) and detection sensitivity and correcting the excitation light source intensity and an image signal on the basis of the measured values.

For example, a technique is known in which a light source intensity is adjusted on the basis of a measurement value of a power meter, and an exposure time is adjusted on the basis of a measurement luminance value of a calibration specimen (see, for example, Patent Document 1). In addition, for example, a technique is known in which a variation in a light source intensity is measured by using a reflection surface attached to a filter cube, a variation in an optical path is measured by using a calibration specimen, and fluorescence image luminance is corrected through image processing as necessary (see, for example, Patent Document 2).

Patent Document 1: JP 2022-119771 A

Patent Document 2: Japanese Patent No. 5593221

### SUMMARY

An optical microscope according to an aspect of the present invention includes an objective lens, a light source configured to output excitation light, an excitation output measurement device configured to measure an excitation output, and a processor configured to measure imaging performance and determine performance of the optical microscope on the basis of a measurement result of the imaging performance and a measurement result of the excitation output.

An optical microscope according to another aspect of the present invention includes an objective lens, a detector configured to detect light from a specimen, a detection sensitivity measurement device configured to measure detection sensitivity, and a processor configured to measure imaging performance and determine performance of the optical microscope on the basis of a measurement result of the imaging performance and a measurement result of the detection sensitivity.

A method according to an aspect of the present invention is a performance determination method of determining performance of an optical microscope, the method including measuring an excitation output, measuring imaging performance, and determining the performance of the optical microscope on the basis of a measurement result of the excitation output and a measurement result of the imaging performance.

A method according to another aspect of the present invention is a performance determination method of determining performance of an optical microscope, the method including measuring detection sensitivity of a detector configured to detect light from a specimen, measuring imaging performance, and determining the performance of the optical microscope on the basis of a measurement result of the detection sensitivity and a measurement result of the imaging performance.

### BRIEF DESCRIPTION OF DRAWINGS

FIG. 1 is a diagram exemplifying a configuration of an optical microscope according to a first embodiment;

FIG. 2 is a diagram exemplifying a functional configuration related to the performance determination function for the optical microscope according to the first embodiment;

FIG. 3 is a diagram exemplifying an abnormality cause (NG cause) stored in a storage unit according to the first embodiment;

FIG. 4 is a diagram exemplifying a functional configuration related to a performance determination function for an optical microscope according to a second embodiment;

FIG. 5 is a diagram exemplifying an abnormality cause (NG cause) stored in a storage unit according to the second embodiment;

FIG. 6 is a diagram exemplifying a functional configuration related to a performance determination function for an optical microscope according to a third embodiment;

FIG. 7 is a flowchart exemplifying processing related to the performance determination function performed by the optical microscope;

FIG. 8 is a diagram exemplifying a determination result for each measurement result, an abnormality cause (NG cause) selected on the basis of the determination result, and a countermeasure against the abnormality cause according to the third embodiment;

FIG. 9 is a diagram for describing an example of a microscope body and an excitation output measurement unit;

FIG. 10 is a diagram for describing an example of a detection sensitivity measurement unit;

FIG. 11 is a diagram for describing an example of an imaging performance measurement unit;

FIG. 12 is a diagram showing an example of measuring imaging performance by using an edge chart specimen;

FIG. 13A is a diagram exemplifying an edge chart specimen;

FIG. 13B is a diagram exemplifying an edge chart specimen;

FIG. 13C is a diagram exemplifying an edge chart specimen;

FIG. 14 is a diagram showing a display example of an evaluation result;

FIG. 15 is a diagram exemplifying a determination result for each measurement result, an abnormality cause (NG cause) selected on the basis of the determination result, and a countermeasure against the abnormality cause according to Modification 1 of the third embodiment;

FIG. 16 is a diagram exemplifying a determination result for each measurement result, an abnormality cause (NG cause) selected on the basis of the determination result, and a countermeasure against the abnormality cause according to Modification 1 of the second embodiment;

FIG. 17 is a diagram exemplifying a determination result for each measurement result, an abnormality cause (NG cause) selected on the basis of the determination result, and a countermeasure against the abnormality cause according to Modification 1 of the first embodiment;

FIG. 18 is a diagram exemplifying a determination result for each measurement result of an irradiation density and an excitation output, an abnormality cause (NG cause) selected on the basis of the determination result, and a countermeasure against the abnormality cause according to Modification 2 of the second or third embodiment;

FIG. 19 is a diagram exemplifying a determination result for each measurement result of the irradiation density and the detection sensitivity, an abnormality cause (NG cause) selected on the basis of the determination result, and a countermeasure against the abnormality cause according to Modification 2 of the third embodiment;

FIG. 20 is a diagram exemplifying a determination result for each measurement result of an irradiation density and imaging performance, an abnormality cause (NG cause) selected on the basis of the determination result, and a countermeasure against the abnormality cause according to Modification 2 of the second or third embodiment;

FIG. 21 is a diagram exemplifying a determination result for each measurement result of an irradiation density, imaging performance, and an excitation output, an abnormality cause (NG cause) selected on the basis of the determination result, and a countermeasure against the abnormality cause according to Modification 2 of the second or third embodiment; and

FIG. 22 is a diagram exemplifying a hardware configuration of a computer.

### DESCRIPTION OF EMBODIMENTS

Embodiments of the present invention will be described below with reference to the drawings.

The detection sensitivity also decreases due to abnormality (including deterioration) in imaging performance (spatial resolution), but, in the conventional technique, the detection sensitivity is evaluated to be reduced without considering the abnormality in imaging performance. That is, the abnormality in the imaging performance was not separately evaluated. As a result, it was not possible to accurately investigate an abnormality cause of a device affected by the imaging performance.

### First Embodiment

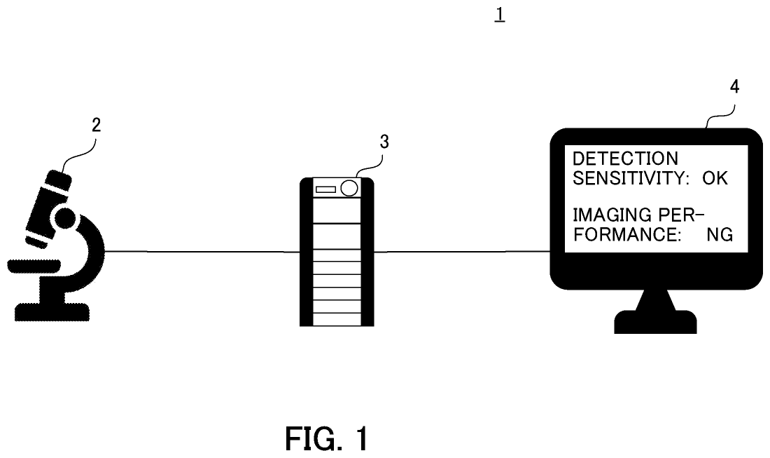

FIG. 1 is a diagram exemplifying a configuration of an optical microscope according to a first embodiment. An optical microscope 1 exemplified in FIG. 1 includes a microscope body 2 and an arithmetic device 3, and may further include a display device 4. The microscope body 2, the arithmetic device 3, and the display device 4 are hardware.

The microscope body 2 includes an objective lens, a light source that outputs excitation light, a detector that detects light from a specimen, and the like. In FIG. 1, the microscope body 2 is shown in a simplified manner, and details thereof will be described later. The arithmetic device 3 is, for example, a general-purpose computer, and performs control of the microscope body 2, generation of a specimen image on the basis of a signal obtained by the microscope body 2, and the like. The display device 4 is, for example, a liquid crystal display, and displays a specimen image generated by the arithmetic device 3.

In addition, the optical microscope 1 has a performance determination function for the optical microscope 1, the arithmetic device 3 also performs performance determination and the like of the optical microscope 1, and the display device 4 also displays a determination result (for example, “detection sensitivity: OK” and “imaging performance: NG”) and the like.

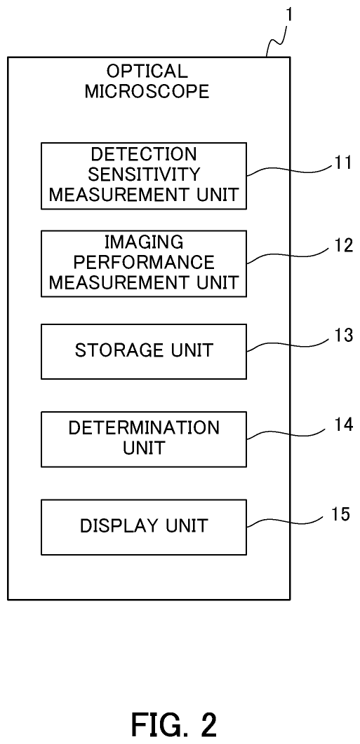

FIG. 2 is a diagram exemplifying a functional configuration related to the performance determination function for the optical microscope according to the first embodiment. The optical microscope 1 exemplified in FIG. 2 includes a detection sensitivity measurement unit 11, an imaging performance measurement unit 12, a storage unit 13, a determination unit 14, and a display unit 15.

The detection sensitivity measurement unit 11 measures the detection sensitivity of the microscope body 2 (detector). The imaging performance measurement unit 12 measures the imaging performance of the microscope body 2. Note that each measurement result (each measurement value) of the detection sensitivity and the imaging performance may be an absolute value or a relative value. Details of the detection sensitivity measurement unit 11 and the imaging performance measurement unit 12 will be described later.

The storage unit 13 stores a detection sensitivity threshold for determining whether the measurement result of the detection sensitivity is normal or abnormal, an imaging performance threshold for determining whether the measurement result of the imaging performance is normal or abnormal, abnormality causes each corresponding to a combination of a determination result for the measurement result of the detection sensitivity and a determination result for the measurement result of the imaging performance, and the like.

The determination unit 14 determines the performance of the optical microscope 1 on the basis of the measurement result of the detection sensitivity and the measurement result of the imaging performance. Specifically, the determination unit 14 compares the measurement result of the detection sensitivity with the detection sensitivity threshold stored in the storage unit 13, and determines whether the measurement result of the detection sensitivity is normal or abnormal on the basis of the comparison result. In addition, the determination unit 14 compares the measurement result of the imaging performance with the imaging performance threshold stored in the storage unit 13, and determines whether the measurement result of the imaging performance is normal or abnormal on the basis of the comparison result. The determination unit 14 outputs a determination result for the measurement result of the detection sensitivity and a determination result for the measurement result of the imaging performance to the display unit 15. In this case, the measurement result of the detection sensitivity and the measurement result of the imaging performance may also be output to the display unit 15.

In addition, the determination unit 14 selects a corresponding abnormality cause from among the abnormality causes stored in the storage unit 13 on the basis of the determination result for the measurement result of the detection sensitivity and the determination result for the measurement result of the imaging performance. The determination unit 14 outputs the selected abnormality cause to the display unit 15, and outputs a countermeasure to be taken by a user of the optical microscope 1 to the display unit 15 on the basis of the selected abnormality cause.

The display unit 15 displays one or more of the measurement results of the detection sensitivity and the imaging performance, the determination result for each measurement result, the abnormality cause, and the countermeasure, output by the determination unit 14. Note that the display unit 15 corresponds to the display device 4.

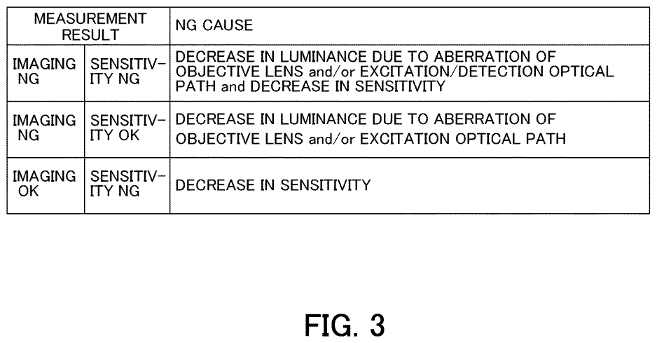

FIG. 3 is a diagram exemplifying an abnormality cause (abnormality cause) stored in the storage unit 13 according to the first embodiment. FIG. 3 exemplifies an abnormality cause (NG cause) corresponding to each combination in a case where one or both of the determination result for the measurement result of the detection sensitivity and the determination result for the measurement result of the imaging performance are abnormal (NG). For example, as an abnormality cause corresponding to a combination in a case where the determination result for the measurement result of the imaging performance is abnormal (imaging NG) and the determination result for the measurement result of the detection sensitivity is abnormal (sensitivity NG), a decrease in luminance due to aberration of an objective lens and/or an excitation/detection optical path (an optical system on the excitation/detection optical path) and a decrease in sensitivity are shown. In the case of this combination, conventionally, the imaging performance has not been taken into consideration, and thus the abnormality cause has been simply regarded to be a decrease in sensitivity. In addition, for example, as an abnormality cause corresponding to a combination in a case where the determination result for the measurement result of the imaging performance is abnormal (imaging NG) and the determination result for the measurement result of the detection sensitivity is normal (sensitivity OK), a decrease in luminance due to aberration of the objective lens and/or the excitation optical path (optical system on the excitation optical path) is shown. In the case of this combination, conventionally, since the imaging performance has not been considered, abnormality has not been determined, and the abnormality has been overlooked.

Details of processing related to the performance determination function performed by the optical microscope 1 according to the first embodiment will be described later.

According to the first embodiment, each of the detection sensitivity and the imaging performance is measured, the normality or abnormality of each measurement result is determined, and an abnormality cause is identified on the basis of each determination result. Therefore, it is possible to separate the abnormality cause caused by the detection sensitivity and the abnormality cause caused by the imaging performance, and it is possible to present an accurate abnormality cause to the user of the optical microscope 1 and to present an appropriate countermeasure.

### Second Embodiment

An optical microscope according to a second embodiment is different from the optical microscope 1 according to the first embodiment in that an excitation output measurement unit is provided instead of the detection sensitivity measurement unit 11. Accordingly, the content stored in the storage unit 13 and determination performed by the determination unit 14 are also different. Hereinafter, the second embodiment will be described focusing on different points. Note that the same elements as those in the first embodiment are denoted by the same reference numerals, and a detailed description thereof will be omitted.

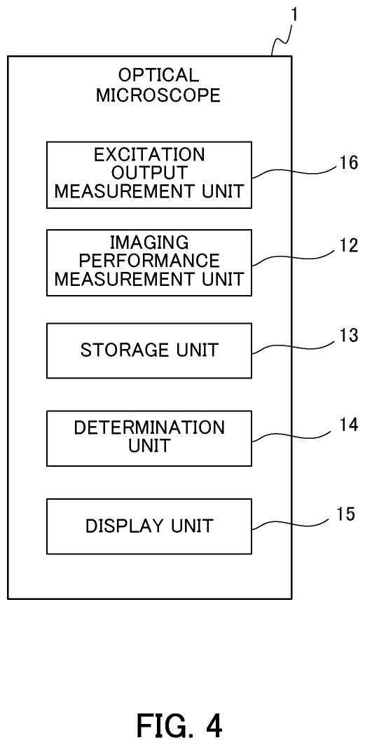

FIG. 4 is a diagram exemplifying a functional configuration related to a performance determination function of the optical microscope according to the second embodiment. The optical microscope 1 shown in FIG. 4 has a configuration including an excitation output measurement unit 16 instead of the detection sensitivity measurement unit 11 in the optical microscope 1 shown in FIG. 2. The excitation output measurement unit 16 measures the excitation output of the microscope body 2. Note that the measurement result (measurement value) of the excitation output may be an absolute value or a relative value. Details of excitation output measurement unit 16 will be described later.

In addition, in the second embodiment, the storage unit 13 stores an excitation output threshold for determining whether the measurement result of the excitation output is normal or abnormal, an imaging performance threshold for determining whether the measurement result of the imaging performance is normal or abnormal, abnormality causes each corresponding to a combination of a determination result for the measurement result of the excitation output and a determination result for the measurement result of the imaging performance, and the like.

In the second embodiment, the determination unit 14 determines the performance of the optical microscope 1 on the basis of the measurement result of the excitation output and the measurement result of the imaging performance. Specifically, the determination unit 14 compares the measurement result of the excitation output with the excitation output threshold stored in the storage unit 13, and determines whether the measurement result of the excitation output is normal or abnormal on the basis of the comparison result. In addition, the determination unit 14 compares the measurement result of the imaging performance with the imaging performance threshold stored in the storage unit 13, and determines whether the measurement result of the imaging performance is normal or abnormal on the basis of the comparison result. The determination unit 14 outputs a determination result for the measurement result of the excitation output and a determination result for the measurement result of the imaging performance to the display unit 15. In this case, the measurement result of the excitation output and the measurement result of the imaging performance may also be output to the display unit 15.

In addition, the determination unit 14 selects a corresponding abnormality cause from the abnormality causes stored in the storage unit 13 on the basis of the determination result for the measurement result of the excitation output and the determination result for the measurement result of the imaging performance. The determination unit 14 outputs the selected abnormality cause to the display unit 15, and outputs a countermeasure to be taken by a user of the optical microscope 1 to the display unit 15 on the basis of the selected abnormality cause.

In addition, in the second embodiment, the display unit 15 displays one or more of measurement results of the excitation output and the imaging performance, a determination result for each measurement result, an abnormality cause, and a countermeasure, output by the determination unit 14.

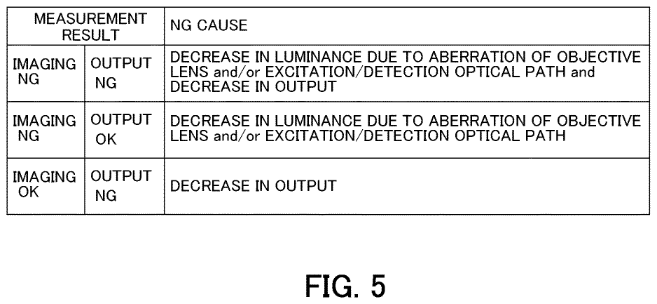

FIG. 5 is a diagram exemplifying an abnormality cause (NG cause) stored in the storage unit according to the second embodiment. FIG. 5 exemplifies an abnormality cause (NG cause) corresponding to each combination in a case where one or both of the determination result for the measurement result of the excitation output and the determination result for the measurement result of the imaging performance are abnormal (NG). For example, as an abnormality cause corresponding to a combination in a case where the determination result for the measurement result of the imaging performance is abnormal (imaging NG) and the determination result for the measurement result of the excitation output is abnormal (output NG), a decrease in luminance due to aberration of the objective lens and/or the excitation/detection optical path and a decrease in output are shown. In the case of this combination, conventionally, since the imaging performance has not been taken into consideration, the abnormality cause has been simply regarded to be a decrease in output. Furthermore, for example, as an abnormality cause corresponding to a combination in a case where the determination result for the measurement result of the imaging performance is abnormal (imaging NG) and the determination result for the measurement result of the excitation output is normal (output OK), a decrease in luminance due to aberration of the objective lens and/or the excitation/detection optical path is shown. In the case of this combination, conventionally, since the imaging performance has not been taken into consideration, abnormality has not been determined, and the abnormality has been overlooked.

Details of processing related to the performance determination function performed by the optical microscope 1 according to the second embodiment will be described later.

According to the second embodiment, each of the excitation output and the imaging performance is measured, the normality or abnormality of each measurement result is determined, and the abnormality cause is identified on the basis of each determination result. Therefore, it is possible to separate the abnormality cause caused by the excitation output and the abnormality cause caused by the imaging performance from each other, and it is possible to present an accurate abnormality cause to a user of the optical microscope 1 and to present an appropriate countermeasure.

### Third Embodiment

An optical microscope according to a third embodiment is different from the optical microscope 1 according to the first embodiment in that the excitation output measurement unit 16 described in the second embodiment is further provided. Accordingly, the content stored in the storage unit 13 and determination performed by the determination unit 14 are also different. Hereinafter, the third embodiment will be described focusing on different points. Note that the same elements as those in the first and second embodiments are denoted by the same reference numerals, and a detailed description thereof will be omitted.

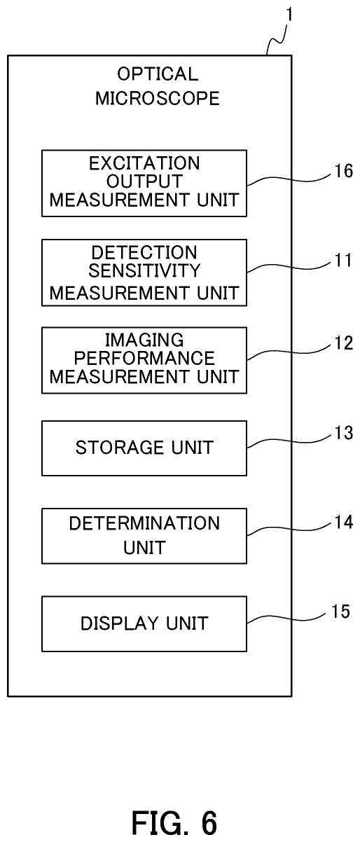

FIG. 6 is a diagram exemplifying a functional configuration related to a performance determination function of the optical microscope according to the third embodiment. The optical microscope 1 exemplified in FIG. 6 has a configuration further including an excitation output measurement unit 16 in the optical microscope 1 exemplified in FIG. 2.

In addition, in the third embodiment, the storage unit 13 stores an excitation output threshold for determining whether the measurement result of the excitation output is normal or abnormal, a detection sensitivity threshold for determining whether the measurement result of the detection sensitivity is normal or abnormal, an imaging performance threshold for determining whether the measurement result of the imaging performance is normal or abnormal, an abnormality cause corresponding to a combination of a determination result for the measurement result of the excitation output, a determination result for the measurement result of the detection sensitivity, and a determination result for the measurement result of the imaging performance, and the like.

In the third embodiment, the determination unit 14 determines the performance of the optical microscope 1 on the basis of the measurement result of the excitation output, the measurement result of the detection sensitivity, and the measurement result of the imaging performance. Specifically, the determination unit 14 compares the measurement result of the excitation output with the excitation output threshold stored in the storage unit 13, and determines whether the measurement result of the excitation output is normal or abnormal on the basis of the comparison result. In addition, the determination unit 14 compares the measurement result of the detection sensitivity with the detection sensitivity threshold stored in the storage unit 13, and determines whether the measurement result of the detection sensitivity is normal or abnormal on the basis of the comparison result. In addition, the determination unit 14 compares the measurement result of the imaging performance with the imaging performance threshold stored in the storage unit 13, and determines whether the measurement result of the imaging performance is normal or abnormal on the basis of the comparison result. The determination unit 14 outputs a determination result for the measurement result of the excitation output, a determination result for the measurement result of the detection sensitivity, and a determination result for the measurement result of the imaging performance to the display unit 15. In this case, the measurement result of the excitation output, the measurement result of the detection sensitivity, and the measurement result of the imaging performance may also be output to the display unit 15.

In addition, the determination unit 14 selects a corresponding abnormality cause from among the abnormality causes stored in the storage unit 13 on the basis of the determination result for the measurement result of the excitation output, the determination result for the measurement result of the detection sensitivity, and the determination result for the measurement result of the imaging performance. The determination unit 14 outputs the selected abnormality cause to the display unit 15, and outputs a countermeasure to be taken by a user of the optical microscope 1 to the display unit 15 on the basis of the selected abnormality cause.

In addition, in the third embodiment, the display unit 15 displays one or more of measurement results of the excitation output, the detection sensitivity, and the imaging performance, a determination result for each measurement result, an abnormality cause, and a countermeasure, output by the determination unit 14.

Details of processing related to the performance determination function performed by the optical microscope 1 according to the third embodiment will be described later.

According to the third embodiment, each of the excitation output, the detection sensitivity, and the imaging performance, which are the three major factors related to the fluorescence intensity, is measured, the normality or abnormality of each measurement result is determined, and the abnormality cause is identified on the basis of each determination result. Therefore, it is possible to separate the abnormality cause caused by the excitation output, the abnormality cause caused by the detection sensitivity, and the abnormality cause caused by the imaging performance from each other, and it is possible to present an accurate abnormality cause to the user of the optical microscope 1, and it is also possible to present an appropriate countermeasure.

For example, in a case where the determination result for the measurement result of the imaging performance is abnormal and the determination result for the measurement result of the excitation output is normal, the abnormality cause is the decrease in luminance due to the aberration of the objective lens and/or the excitation/detection optical path as exemplified in FIG. 5. In addition, in a case where the determination result for the measurement result of the detection sensitivity is normal, the abnormality cause can be narrowed down to the decrease in luminance due to the aberration of the objective lens and/or the excitation optical path.

In the third embodiment, in a case where the excitation light is used to measure the detection sensitivity, the measurement value in the detector can be normalized by the measurement value of the excitation output. This makes it possible to improve the measurement accuracy of the detection sensitivity and simplify the measurement unit.

### Processing Related to Performance Determination Function Performed by Optical Microscope 1

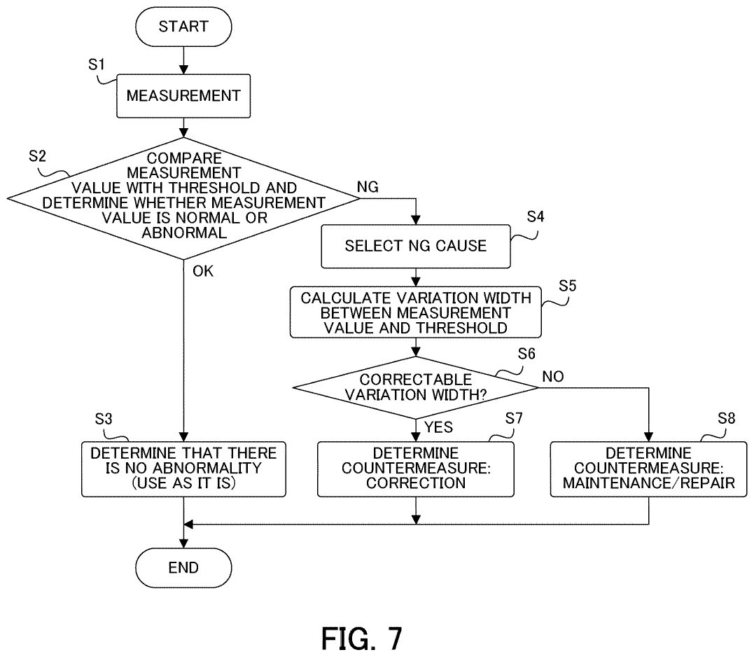

In the first to third embodiments, the processing exemplified in FIG. 7 is performed as the processing related to the performance determination function performed by the optical microscope 1.

FIG. 7 is a flowchart exemplifying processing related to the performance determination function performed by the optical microscope. Note that, in starting this processing, it is assumed that each threshold, each abnormality cause, and each correctability threshold are stored in the storage unit 13 in advance.

Specifically, in the first embodiment, it is assumed that a detection sensitivity threshold and an imaging performance threshold are stored as each threshold, an abnormality cause corresponding to each combination in a case where one or both of a determination result for a measurement result of detection sensitivity and a determination result for a measurement result of imaging performance are abnormal is stored as each abnormality cause, and a detection sensitivity correctability threshold is stored as a correctability threshold. The detection sensitivity correctability threshold is a threshold for determining whether or not the detection sensitivity can be corrected on the basis of the measurement result of the detection sensitivity determined to be abnormal.

In the second embodiment, it is assumed that an excitation output threshold and an imaging performance threshold are stored as each threshold, an abnormality cause corresponding to each combination in a case where one or both of a determination result for a measurement result of excitation output and a determination result for a measurement result of imaging performance are abnormal is stored as each abnormality cause, and an excitation output correctability threshold is stored as a correctability threshold. The excitation output correctability threshold is a threshold for determining whether or not the excitation output can be corrected on the basis of the measurement result of the excitation output determined to be abnormal.

In the third embodiment, it is assumed that an excitation output threshold, a detection sensitivity threshold, and an imaging performance threshold are stored as each threshold, an abnormality cause corresponding to each combination in a case where one or more of a determination result for a measurement result of excitation output, a determination result for a measurement result of detection sensitivity, and a determination result for a measurement result of imaging performance is abnormal is stored as each abnormality cause, and an excitation output correctability threshold and a detection sensitivity correctability threshold are stored as each correctability threshold.

In the processing exemplified in FIG. 7, first, each measurement unit performs measurement (step S1). Specifically, in the first embodiment, the detection sensitivity measurement unit 11 measures the detection sensitivity, and the imaging performance measurement unit 12 measures the imaging performance. In the second embodiment, the excitation output measurement unit 16 measures the excitation output, and the imaging performance measurement unit 12 measures the imaging performance. In the third embodiment, the excitation output measurement unit 16 measures the excitation output, the detection sensitivity measurement unit 11 measures the detection sensitivity, and the imaging performance measurement unit 12 measures the imaging performance.

Next, the determination unit 14 compares each measurement result (each measurement value) with a corresponding threshold, and determines whether each measurement result is normal or abnormal (step S2). Specifically, in the first embodiment, the measurement result of the detection sensitivity is compared with the detection sensitivity threshold, and the measurement result of the imaging performance is compared with the imaging performance threshold to determine whether each measurement result is normal or abnormal. In the second embodiment, the measurement result of the excitation output is compared with the excitation output threshold, and the measurement result of the imaging performance is compared with the imaging performance threshold to determine whether each measurement result is normal or abnormal. In the third embodiment, the measurement result of the excitation output is compared with the excitation output threshold, the measurement result of the detection sensitivity is compared with the detection sensitivity threshold, and the measurement result of the imaging performance is compared with the imaging performance threshold to determine whether each measurement result is normal or abnormal.

In a case where it is determined in step S2 that all the measurement results are normal (OK in step S2), the determination unit 14 determines that there is no abnormality and determines to continue use as it is (step S3). In this case, the determination unit 14 may output the determination result (normal) for each measurement result to the display unit 15, and the display unit 15 may display the determination result.

On the other hand, when it is determined in step S2 that at least one of the measurement results is abnormal (NG in step S2), the processing proceeds to step S4. In step S4, the determination unit 14 selects a corresponding abnormality cause (NG cause) from among the abnormality causes stored in the storage unit 13 on the basis of the determination result for each measurement result. Specifically, in the first embodiment, the corresponding abnormality cause is selected on the basis of the determination result for the measurement result of the detection sensitivity and the determination result for the measurement result of the imaging performance. In the second embodiment, the corresponding abnormality cause is selected on the basis of the determination result for the measurement result of the excitation output and the determination result for the measurement result of the imaging performance. In the third embodiment, the corresponding abnormality cause is selected on the basis of the determination result for the measurement result of the excitation output, the determination result for the measurement result of the detection sensitivity, and the determination result for the measurement result of the imaging performance.

Note that, in step S4, the determination unit 14 may output the selected abnormality cause to the display unit 15, and the display unit 15 may display the abnormality cause, or the determination unit 14 may further output each measurement result and/or the determination result for each measurement result to the display unit 15, and the display unit 15 may further display the measurement result and/or the determination result.

Next, the determination unit 14 calculates a variation width (difference) between the measurement result (measurement value) (here, the measurement result (measurement value) of the imaging performance is excluded) determined to be abnormal in step S2 and the corresponding threshold (step S5), and determines whether the variation width is less than the corresponding correctability threshold (that is, whether or not the variation width is a correctable variation width) (step S6). Specifically, in the first embodiment, in a case where the measurement result of the detection sensitivity is determined to be abnormal, a variation width (detection sensitivity variation width) between the measurement result of the detection sensitivity and the detection sensitivity threshold is calculated, and it is determined whether or not the detection sensitivity variation width is less than the detection sensitivity correctability threshold. In the second embodiment, when the measurement result of the excitation output is determined to be abnormal, a variation width (excitation output variation width) between the measurement result of the excitation output and the excitation output threshold is calculated, and it is determined whether or not the excitation output variation width is less than the excitation output correctability threshold. In the third embodiment, when the measurement result of the excitation output and/or the measurement result of the detection sensitivity are determined to be abnormal, the excitation output variation width and/or the detection sensitivity variation width are calculated, and it is determined whether the excitation output variation width is less than the excitation output correctability threshold and/or whether the detection sensitivity variation width is less than the detection sensitivity correctability threshold.

In a case where the determination result for the measurement result other than the imaging performance is normal, step S5 is skipped. In addition, in a case where the determination result for the measurement result of the imaging performance is abnormal, or in a case where the optical microscope 1 does not include a correction mechanism (a mechanism for performing correction), the determination result in step S6 is processed as NO, and the processing proceeds to step S8. As a result, in a case where the determination result for the measurement result of the imaging performance is abnormal, the processing proceeds to step S8 without proceeding to step S7, but this is to give priority to coping with the abnormality cause of the imaging performance, and details thereof will be described later.

In step S6, in a case where the determination result for the measurement result of the imaging performance is normal and the optical microscope 1 includes a correction mechanism, if it is determined that the variation width calculated in step S5 is a correctable variation width (YES in step S6), the processing proceeds to step S7, and otherwise (NO in step S6), the processing proceeds to step S8.

In step S7, the determination unit 14 determines a countermeasure by correction as a countermeasure against the abnormality cause selected in step S4, outputs the countermeasure by the correction to the display unit 15, and the display unit 15 displays the countermeasure. When the countermeasure by the correction is determined, the correction is then performed. The correction may be performed automatically by the correction function of the optical microscope 1 or may be performed manually by the user of the optical microscope 1. The excitation output is corrected, for example, by adjusting the excitation output by controlling an acousto optic modulator (AOM) provided at a subsequent stage of a light source or controlling a laser diode (LD) drive current of the light source. The detection sensitivity is corrected, for example, by adjusting the amount of light incident on the detector to such an extent that the imaging performance (spatial resolution) is not significantly affected by adjustment of an incident optical axis to a confocal pinhole using a beam shifter provided at the front stage of the confocal pinhole or adjustment of a pinhole diameter of the confocal pinhole.

In step S8, the determination unit 14 determines a countermeasure by maintenance/repair as a countermeasure against the abnormality cause selected in step S4, outputs the countermeasure by maintenance/repair to the display unit 15, and the display unit 15 displays the countermeasure. When a countermeasure by maintenance/repair is determined, maintenance/repair is then performed. In the maintenance, cleaning of the objective lens, cleaning of the chart specimen (immersion liquid (oil) wiping, and the like), adjustment of a correction ring of the objective lens, and the like are performed. Repair is performed on a device that cannot be handled without contacting a service of a manufacturer, such as a decrease in luminance due to an excitation optical path or a detection optical path.

According to the processing related to the performance determination function as described above, it is possible to cause the display unit 15 to display a countermeasure against the abnormality cause, so that the user of the optical microscope 1 can take an appropriate countermeasure without hesitation by checking the display content.

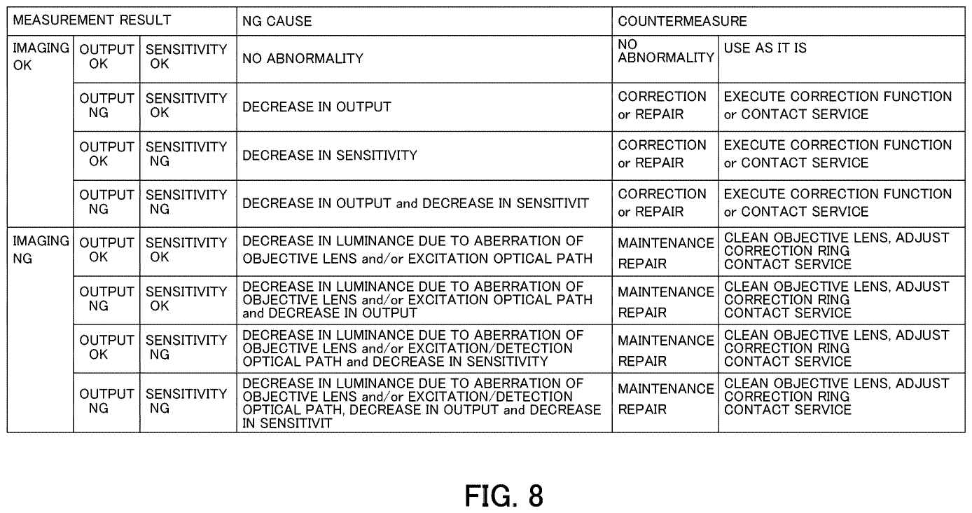

FIG. 8 is a diagram exemplifying a determination result for each measurement result, an abnormality cause (NG cause) selected on the basis of the determination result, and a countermeasure against the abnormality cause according to the third embodiment. However, in FIG. 8, in a case where the determination results for the respective measurement results of the imaging performance, the excitation output, and the detection sensitivity are all normal (imaging OK, output OK, sensitivity OK), “no abnormality” is shown as the abnormality cause, and “no abnormality, use as it is” is shown as the countermeasure.

As exemplified in FIG. 8, in a case where the determination result for the measurement result of the imaging performance is normal (imaging OK) and the determination result for one or both of the determination result of the excitation output and the measurement result of the detection sensitivity is abnormal (NG), the countermeasure is correction (execution of the correction function) or repair (contact a service).

On the other hand, in a case where the determination result for the measurement result of the imaging performance is abnormal (imaging NG), regardless of whether the determination result for the measurement result of each of the excitation output and the detection sensitivity is normal or abnormal, the countermeasure is maintenance (cleaning of the objective lens, adjustment of the correction ring) or repair (contact a service). In this case, even in a case where the determination result for one or both of the measurement results of the excitation output and the detection sensitivity is abnormal (NG), the countermeasure does not include correction. This is because, in a case where the determination result for one or both of the measurement results of the excitation output and the detection sensitivity is abnormal, the abnormality cause may be caused by the abnormality cause of the imaging performance. Therefore, in such a case, in order to give priority to coping with the abnormality cause of the imaging performance, the countermeasure is maintenance/repair, and does not include correction. The same applies to the first and second embodiments, and in a case where both the determination result for the measurement result of the imaging performance and the determination result for the other measurement result are abnormal, in order to give priority to coping with the abnormality cause of the imaging performance, the countermeasure is maintenance/repair, and does not include correction.

### Microscope Body 2 and Excitation Output Measurement Unit 16

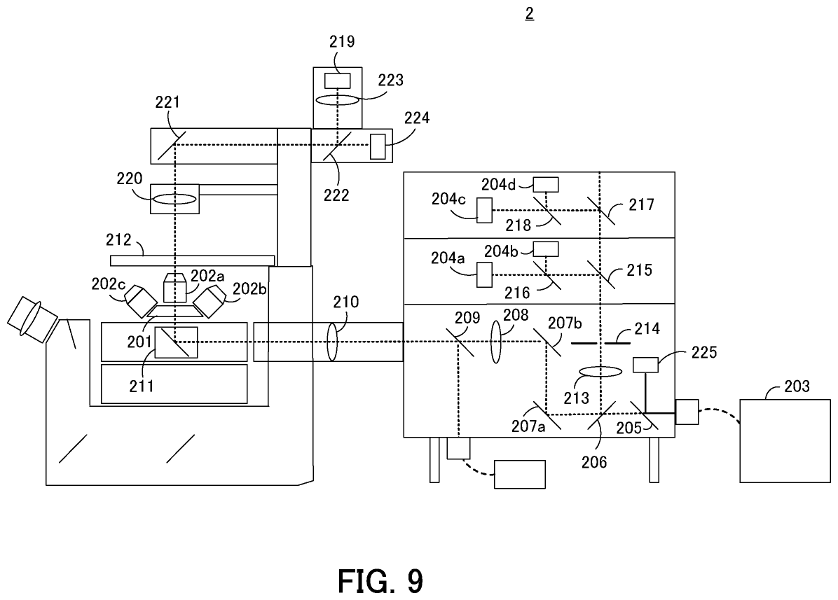

FIG. 9 is a diagram for describing an example of the microscope body and the excitation output measurement unit. In this example, it is assumed that the optical microscope 1 is a laser scanning confocal fluorescence microscope.

The microscope body 2 exemplified in FIG. 9 is a laser scanning confocal fluorescence microscope body, and includes a plurality of objective lenses 202 (202a, 202b, 202c) attached to a revolver 201, a laser light source 203 that outputs excitation light, a plurality of detectors 204 (204a, 204b, 204c, 204d) that detect light (fluorescence) from a specimen, and the like. The constituents of the microscope body 2 shown in FIG. 9 are hardware.

In the microscope body 2, light emitted from the laser light source 203 passes through a beam splitter 205, a dichroic mirror 206, a pair of galvano mirrors 207, a lens 208, a dichroic mirror 209, a lens 210, a fluorescence cube 211, and the objective lens 202, and is applied as excitation light to a specimen (not shown) placed on a stage 212. Such an optical path through which light emitted from the laser light source 203 reaches the specimen is an excitation optical path. Note that an AOM may be further provided in the optical path between the laser light source 203 and the beam splitter 205.

The fluorescence generated by irradiating the specimen with the excitation light passes through the objective lens 202, the fluorescence cube 211, the lens 210, the dichroic mirror 209, the lens 208, the pair of galvano mirrors 207, the dichroic mirror 206, the lens 213, and the confocal pinhole 214, and then passes through the dichroic mirrors 215 and 216 to be detected by the detectors 204a and/or 204b, and/or passes through the dichroic mirrors 215, 217, and 218 to be detected by the detectors 204c and/or 204d. Such an optical path through which the fluorescence from the specimen reaches the detector 204 is a detection optical path. Note that a beam shifter may be further provided in the optical path between the lens 213 and the confocal pinhole 214.

Further, the microscope body 2 includes a transmission detector 219, and the transmission detector 219 can detect light transmitted through the specimen placed on the stage 212. In this case, the light transmitted through the specimen passes through the condenser lens 220, the mirrors 221 and 222, and the lens 223, and is detected by the transmission detector 219. In addition, the microscope body 2 includes a transmission illumination light source 224, and the transmission illumination light source 224 can illuminate the specimen placed on the stage. In this case, the mirror 222 flips up, and the illumination light from the transmission illumination light source 224 illuminates the specimen via the mirror 221 and the condenser lens 220.

In addition, in the microscope body 2, the excitation output measurement unit 16 is realized by using an excitation light intensity monitor 225. The excitation light intensity monitor 225 is, for example, a photodiode. The excitation light intensity monitor 225 measures the intensity of light (excitation light) branched by the beam splitter 205 from the laser light source 203. The measurement result at this time is the measurement result in the excitation output measurement unit 16.

Note that the excitation light intensity monitor 225 may be provided at another position. For example, the excitation light intensity monitor 225 may be built in the laser light source 203. Alternatively, the excitation light intensity monitor 225 may be provided at a position where it can be taken in and out of the main optical path, such as an objective lens mounting hole of the revolver 201. Alternatively, the excitation light intensity monitor 225 may be provided in the vicinity of the specimen surface, such as the back surface of the stage 212. Alternatively, the excitation light intensity monitor 225 may be provided further toward the transmission side than the specimen surface. In this case, the excitation light intensity monitor 225 may be provided in the vicinity of the condenser lens 220 or the like. As described above, the excitation light intensity monitor 225 may be provided in the optical path closer to the laser light source 203 side than the objective lens 202, in the vicinity of the focal plane of the objective lens 202, or in the optical path on the opposite side to the objective lens 202 with the focal plane of the objective lens 202 interposed therebetween. The transmission detector 219 may be used as the excitation light intensity monitor 225. At the time of measuring the excitation output, the specimen is not placed on the stage 212. In a case where the excitation light intensity monitor 225 is provided at another position in this manner, the beam splitter 205 can be unnecessary.

Note that the excitation light intensity monitor 225 and the transmission detector 219 used as the excitation light intensity monitor 225 are examples of an excitation output measurement device that is hardware for measuring excitation output.

### Detection Sensitivity Measurement Unit 11

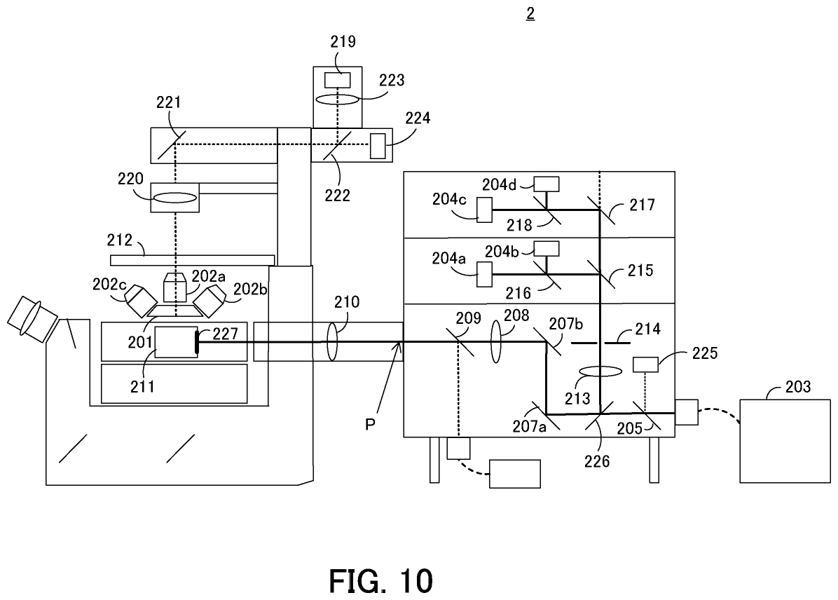

FIG. 10 is a diagram for describing an example of the detection sensitivity measurement unit.

The detection sensitivity measurement unit 11 is realized by using the detector 204. Specifically, as exemplified in FIG. 10, a reflection element 227 is provided in the fluorescence cube 211, the dichroic mirror 206 is replaced with a partial reflection mirror 226, and the pinhole diameter of the confocal pinhole 214 is adjusted in order to optimize the amount of light incident on the detector 204 at the time of measuring the detection sensitivity. The light emitted from the laser light source 203 is reflected by a reflection element 227 via the partial reflection mirror 226 and the like, and the reflected light is detected by the detector 204 via the partial reflection mirror 226 and the like. As a result, the detection sensitivity measurement unit 11 is realized. The detection result of the detector 204 at this time is the measurement result of the detection sensitivity measurement unit 11. The reflection element 227 may be a planar reflection element or a corner cube prism. The laser light source 203 may further include a reference light source that emits light for detection sensitivity measurement at the time of detection sensitivity measurement.

Note that the reflection element 227 may be provided anywhere in the optical path between the partial reflection mirror 226 and the objective lens 202. For example, the reflection element 227 may be provided in an objective lens mounting hole of the revolver 201 or a differential interference observation prism attachment/detachment portion provided to be insertable into/detachable from an optical path. In addition, the reflection element 227 may be provided on the stage 212 or the like in a state in which the objective lens 202 is detached.

Alternatively, the detection sensitivity measurement unit 11 may be realized as follows. The detection sensitivity measurement unit 11 may be realized by disposing a phosphor at a primary image position P in the optical path, irradiating the phosphor with light from the laser light source 203, and detecting fluorescence from the phosphor generated by the irradiation by using the detector 204. In this case, it is not necessary to replace the dichroic mirror 206 with the partial reflection mirror 226.

Alternatively, the detection sensitivity measurement unit 11 may be realized as follows. The detection sensitivity measurement unit 11 may be realized by fixing a reference specimen such as a fluorescent specimen or a reflective specimen in the vicinity of the specimen surface such as the back surface of the stage, inserting a reference objective lens (for example, the objective lens 202a) into the optical path, irradiating the reference specimen with light from the laser light source 203, and detecting light (fluorescence or reflected light) from the reference specimen by using the detector 204. When the fluorescent specimen is used as a reference specimen, it is not necessary to replace the dichroic mirror 206 with the partial reflection mirror 226.

Alternatively, the detection sensitivity measurement unit 11 may be realized as follows. The detection sensitivity measurement unit 11 may be realized by fixing the reference light source to the specimen surface or the back surface of the stage, inserting the reference objective lens (for example, the objective lens 202a) into the optical path, and then detecting the light from the reference light source by the detector 204.

Alternatively, the detection sensitivity measurement unit 11 may be realized as follows. The detection sensitivity measurement unit 11 may be realized by flipping up the mirror 222 and then detecting the light from the transmission illumination light source 224 by using the detector 204.

As described above, the detection sensitivity measurement unit 11 may be realized by including the reflection element 227 or the phosphor provided in the optical path closer to the laser light source 203 side than the objective lens 202, the reference specimen or the reference light source disposed in the vicinity of the focal position of the objective lens 202, or the light source provided on the opposite side to the objective lens 202 with the focal position of the objective lens 202 interposed therebetween.

Note that the detector 204 at the time of measuring the detection sensitivity is an example of a detection sensitivity measurement device which is hardware for measuring the detection sensitivity.

### Imaging Performance Measurement Unit 12

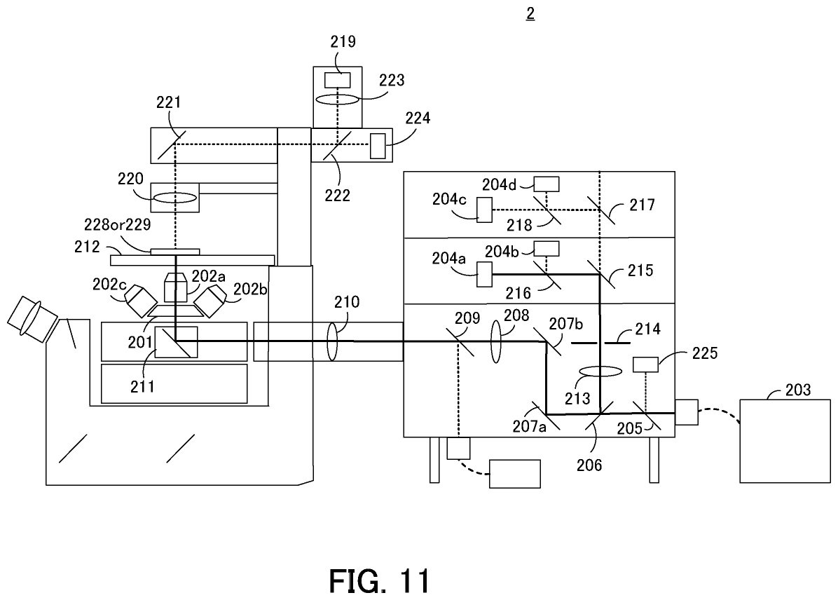

FIG. 11 is a diagram for describing an example of the imaging performance measurement unit.

The imaging performance measurement unit 12 is realized by using the detector 204 and the arithmetic device 3. Specifically, as exemplified in FIG. 11, a fluorescent bead specimen 228 or a pinhole specimen 229 is placed on the stage 212 (in a case where the pinhole specimen 229 is placed, the dichroic mirror 206 is further replaced with a partial reflection mirror), and the confocal pinhole 214 is set to about 2 AU (Airy Unit) instead of 1 AU in order to easily monitor the aberration outside the focal point. The fluorescent bead specimen 228 or the pinhole specimen 229 is irradiated with light from the laser light source 203 while being two-dimensionally scanned by the pair of galvano mirrors 207, and light (fluorescence or reflected light) from the fluorescent bead specimen 228 or the pinhole specimen 229 is detected by the detector 204 (for example, 204a). The arithmetic device 3 generates a fluorescent bead specimen image or a pinhole specimen image on the basis of the detection result, and the arithmetic device 3 calculates a point spread function (PSF) on the basis of the fluorescent bead specimen image or the pinhole specimen image. Thus, the imaging performance measurement unit 12 is realized. The PSF calculated by the arithmetic device 3 at this time is a measurement result in the imaging performance measurement unit 12. As described above, the imaging performance measurement unit 12 may be realized by acquiring an image of the reference specimen (the fluorescent bead specimen 228 or the pinhole specimen 229) disposed at the focal position of the objective lens 202 and calculating the PSF on the basis of the image.

Alternatively, the imaging performance measurement unit 12 may be realized as follows. After a wavefront sensor is provided on the stage 212, light from the laser light source 203 is applied to the wavefront sensor, and a wavefront of the applied light is measured by the wavefront sensor. The arithmetic device 3 calculates the PSF on the basis of the measurement result. Thus, the imaging performance measurement unit 12 may be realized. As described above, the imaging performance measurement unit 12 may be realized by measuring a wavefront of the excitation light in the focal plane of the objective lens 202 and calculating the PSF on the basis of the measured wavefront.

Alternatively, the imaging performance measurement unit 12 may be realized as follows. An edge chart specimen, which is an example of an edge specimen, is placed on the stage 212, the dichroic mirror 206 is replaced with a partial reflection mirror, and the confocal pinhole 214 is set to about 2 AU. The edge chart specimen is irradiated with light from the laser light source 203 while being two-dimensionally scanned by the pair of galvano mirrors 207, and light (reflected light) from the edge chart specimen is detected by the detector 204 (for example, 204a). The arithmetic device 3 generates an edge chart specimen image on the basis of the detection result, and the arithmetic device 3 calculates a line spread function (LSF) on the basis of the edge chart specimen image. Thus, the imaging performance measurement unit 12 may be realized. The LSF calculated by the arithmetic device 3 at this time is a measurement result in the imaging performance measurement unit 12. Alternatively, the arithmetic device 3 may calculate a correlation coefficient between the calculated LSF and a theoretical LSF (an LSF in the case of non-aberration) that is a theoretical value, and use the correlation coefficient as a measurement result in the imaging performance measurement unit 12. As described above, the imaging performance measurement unit 12 may be realized by acquiring an image of the edge specimen disposed at the focal position of the objective lens 202 and calculating an LSF (or a correlation coefficient with the theoretical LSF) on the basis of the image.

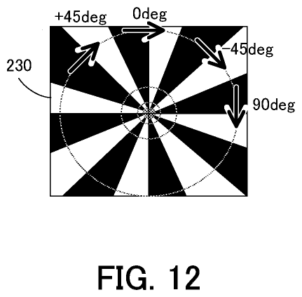

FIG. 12 is a diagram showing an example of measuring the imaging performance by using the edge chart specimen. In the example shown in FIG. 12, Z-stack imaging is performed on the reflected light of the edge chart specimen 230, edge responses in four directions indicated by arrows are acquired, and LSFs in the four directions are calculated. In each LSF, the horizontal axis direction indicates the Z direction (the optical axis direction of the objective lens 202 in the optical path), and the vertical axis direction indicates the X direction (or the Y direction). A correlation coefficient between each of the LSFs in the four directions and the theoretical LSF is calculated as the imaging performance. Note that the Z-stack imaging is performed so that the influence of the image blur due to the defocus can be eliminated later, and the aberration is determined from the blur in the Z direction. In addition, directions in which the edge response is acquired may be at least four directions, and may be eight directions in the entire circumference of 360°. As a result, it is also possible to evaluate the difference in the degree of collapse of the LSF depending on the direction.

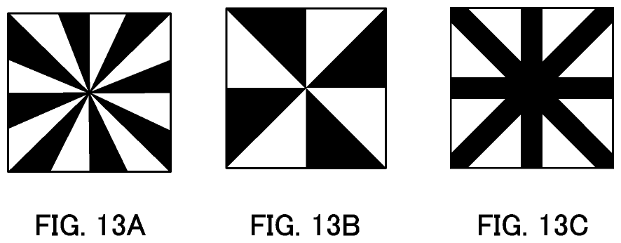

FIGS. 13A, 13B, and 13C are diagrams exemplifying edge chart specimens. Each of the edge chart specimens exemplified in FIGS. 13A, 13B, and 13C has a radial pattern. By using such an edge chart specimen, the imaging performance can be evaluated in various directions. The edge chart specimen may have a radial pattern having edges in eight or more directions over the entire circumference of 360°.

In addition, when the imaging performance is measured by using the edge chart specimen, the LSF may be further decomposed into the aberration amount, and the aberration amount, the aberration level, and the like may be displayed on the display unit 15 (display device 4) as an evaluation result. In this case, the aberration amount may be classified into coma aberration, spherical aberration, and astigmatism and displayed. In addition, the presence or absence of aberration or a value quantified in any unit may be displayed. The aberration level may be determined on the basis of comparison between the aberration amount and the threshold. The threshold in this case may be, for example, a Strehl ratio, a full width at half maximum (FWHM), a wavefront aberration root mean square (RMS), or may be set by AI.

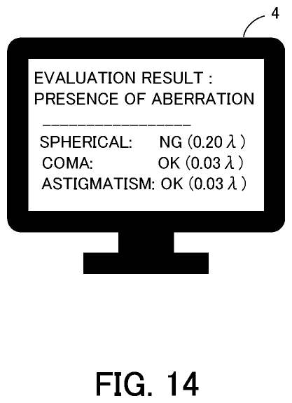

FIG. 14 is a diagram showing a display example of the evaluation result. In the display example shown in FIG. 14, the presence of the aberration, the spherical aberration being at the NG level and the coma aberration and the astigmatism being at the OK level, and the wavefront aberration RMS of the spherical aberration, the coma aberration, and the astigmatism are displayed on the display device 4 as the evaluation results.

### Items Common to Each Measurement of Excitation Output, Detection Sensitivity, and Imaging Performance

In each measurement of the excitation output, the detection sensitivity, and the imaging performance, measurement is performed with the excitation wavelength set to one wavelength and the detection wavelength set to one wavelength or more. In a case where the measurement of the excitation output, the detection sensitivity, and the imaging performance is performed at substantially the same timing and a value of the light source intensity of the laser light source 203 is used for the measurement of the detection sensitivity, in the measurement order, the measurement of the excitation output and the detection sensitivity comes first, and the measurement of the imaging performance comes later. This is because a specimen is always used in the measurement of the imaging performance, so that it takes time to perform the measurement, and there is a possibility that the two performances of the excitation output and the detection sensitivity fluctuate during the measurement.

### Modification 1 of Each of First to Third Embodiments

In the measurement of the detection sensitivity in the optical microscope 1 according to each of the first and third embodiments, the following measurement may be further performed, and in the measurement of the imaging performance in the optical microscope 1 according to each of the first to third embodiments, the following measurement may be further performed.

In the measurement of the detection sensitivity, the incident optical axis to the confocal pinhole 214 may be further shifted by a beam shifter or the like, and the detection sensitivity for each shift amount may be measured. The arithmetic device 3 may measure a deviation amount of the incident optical axis to the confocal pinhole 214 on the basis of a measurement result of the detection sensitivity when the incident optical axis is not shifted (a measurement result of the detection sensitivity as before) and a measurement result of the detection sensitivity when the incident optical axis is shifted. In this case, for example, it is possible to determine whether the incident optical axis to the confocal pinhole 214 is normal or abnormal by determining whether the deviation amount of the incident optical axis to the confocal pinhole 214 is equal to or more than a threshold. As a result, it is possible to identify whether the abnormality cause for the measurement result of the detection sensitivity is caused by the detector 204 and/or the detection optical path or caused by the deviation of the incident optical axis to the confocal pinhole 214.

In the measurement of the imaging performance, the imaging performance may be measured by using each of the plurality of objective lenses 202. In this case, the determination unit 14 may determine whether each of the measurement results of the imaging performance using the plurality of respective objective lenses 202 is normal or abnormal. As a result, it is possible to more accurately identify the abnormality cause for the measurement result of the imaging performance on the basis of each measurement result. For example, in a case where the determination result for the measurement result of the imaging performance is abnormal and all the determination results for the measurement results of the imaging performance using the plurality of respective objective lenses 202 are also abnormal, it is difficult to consider that all the objective lenses 202 are abnormal. Therefore, it can be identified that the abnormality cause for the measurement result of the imaging performance is not the objective lens 202 but the decrease in luminance caused by the aberration of the excitation/detection optical path.

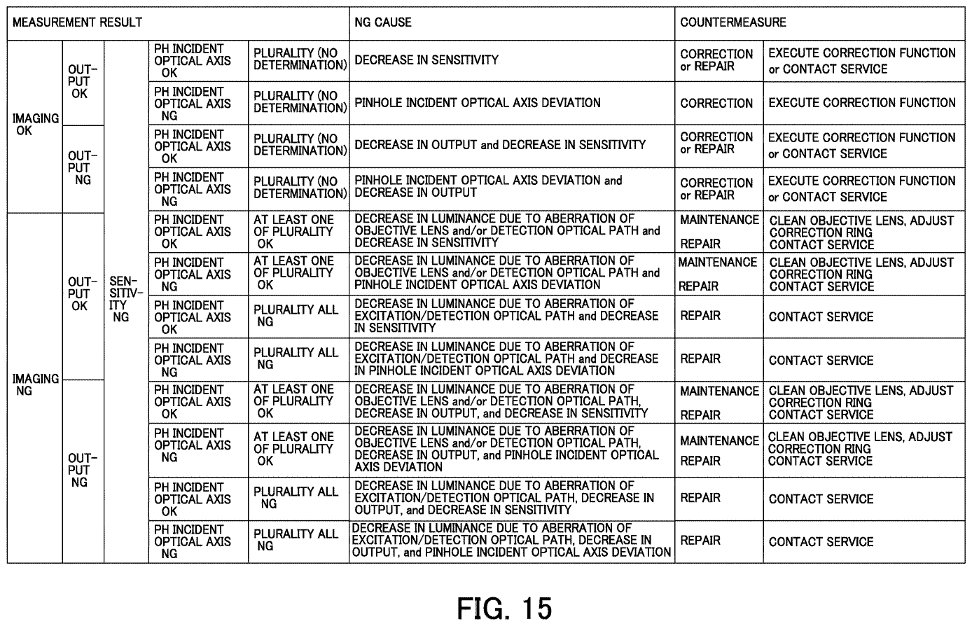

FIG. 15 is a diagram exemplifying a determination result for each measurement result, an abnormality cause (NG cause) selected on the basis of the determination result, and a countermeasure against the abnormality cause according to Modification 1 of the third embodiment.

In the example shown in FIG. 15, a determination result as to whether the incident optical axis to the confocal pinhole 214 is normal or abnormal and a determination result for the measurement result of the imaging performance using the plurality of respective objective lenses 202 are further added as the determination results. “PH incident optical axis OK” indicates that the incident optical axis to the confocal pinhole 214 is determined to be normal, and “PH incident optical axis NG” indicates that the incident optical axis to the confocal pinhole 214 is determined to be abnormal. “Plurality ALL NG” indicates that all of the measurement results of the imaging performance using the plurality of respective objective lenses 202 are determined to be abnormal, and “at least one of plurality OK” indicates that one or more of the measurement results of the imaging performance using the plurality of respective objective lenses 202 are determined to be normal. In a case where the determination result for the measurement result of the imaging performance is normal (imaging OK), the determination for the measurement result of the imaging performance using the plurality of respective objective lenses 202 is not performed, and this is indicated as “plurality (no determination)”.

According to the example shown in FIG. 15, in a case where the determination result for the measurement result of the detection sensitivity is abnormal (sensitivity NG) or in a case where the determination result for the measurement result of the imaging performance is abnormal (imaging NG), a more accurate abnormality cause can be selected, and a more appropriate countermeasure can be presented.

Note that, although not shown in FIG. 15, in a case where the determination result for the measurement result of the detection sensitivity is normal (sensitivity OK), for example, the determination as to whether the incident optical axis to the confocal pinhole 214 is normal or abnormal and the determination for the measurement result of the imaging performance using each of the plurality of objective lenses 202 are not performed, and the determination may be similar to those shown in FIG. 8.

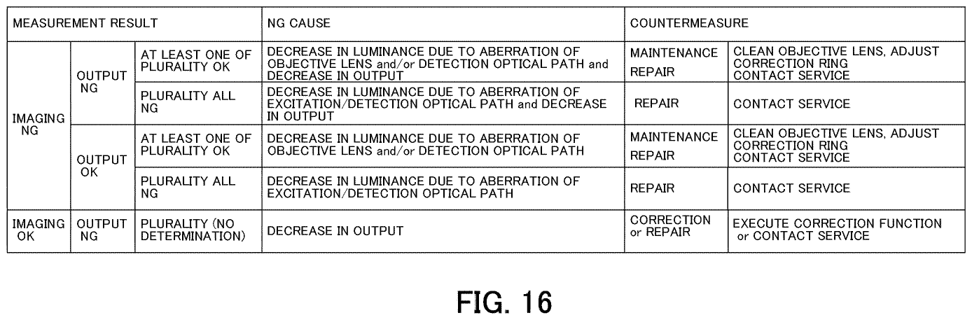

FIG. 16 is a diagram exemplifying a determination result for each measurement result, an abnormality cause (NG cause) selected on the basis of the determination result, and a countermeasure against the abnormality cause according to Modification 1 of the second embodiment.

In the example shown in FIG. 16, a determination result for the measurement result of the imaging performance using each of the plurality of objective lenses 202 is further added as the determination result. According to this example, in a case where the determination result for the measurement result of the imaging performance is abnormal (imaging NG), a more accurate abnormality cause can be selected, and a more appropriate countermeasure can be presented.

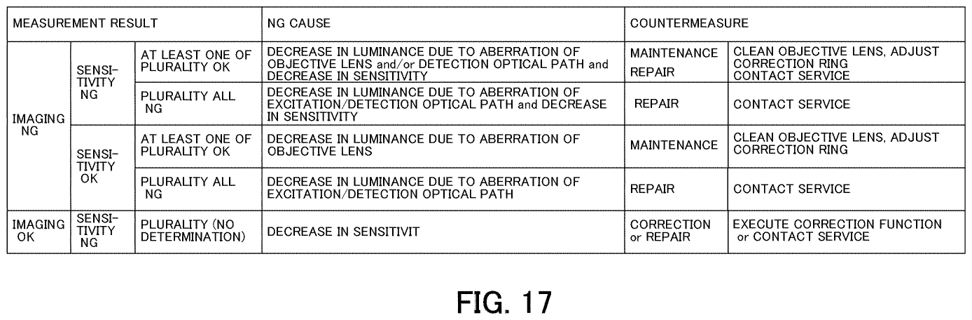

FIG. 17 is a diagram exemplifying a determination result for each measurement result, an abnormality cause (NG cause) selected on the basis of the determination result, and a countermeasure against the abnormality cause according to Modification 1 of the first embodiment.

In the example shown in FIG. 17, a determination result for the measurement result of the imaging performance using each of the plurality of objective lenses 202 is further added as the determination result. According to this example, when the determination result for the measurement result of the imaging performance is abnormal (imaging NG), a more accurate abnormality cause can be selected, and a more appropriate countermeasure can be presented.

Note that, in Modification 1, the determination unit 14 determines whether the incident optical axis to the confocal pinhole 214 is normal or abnormal (determines “PH incident optical axis OK” or “PH incident optical axis NG”), and performs determination for the measurement result of the imaging performance using each of the plurality of objective lenses 202 (determination of “plurality ALL NG” or “at least one of plurality OK”). In addition, an abnormality cause corresponding to each combination of determination results is stored in the storage unit 13 in advance. The corresponding abnormality cause is selected by the determination unit 14 on the basis of each determination result.

In Modification 1, in addition to the measurement of the detection sensitivity, the detection sensitivity may be measured by using each of a plurality of detection channels (for example, a plurality of detectors 204), and the measurement result of the detection sensitivity using each of the plurality of detection channels may be used to identify the abnormality cause in a case where the determination result for the measurement result of the detection sensitivity is abnormal. For example, in a case where the determination result for the measurement result of the detection sensitivity is abnormal, the determination results for the measurement result of the detection sensitivity using the plurality of respective detection channels are all also abnormal, and the incident optical axis to the confocal pinhole 214 is determined to be normal, a decrease in luminance due to aberration of the detection optical path (the optical system on the detection optical path) and/or a decrease in sensitivity of the detection optical path other than the detector can be identified as the abnormality cause. In addition, in a case where the determination result for the measurement result of the imaging performance is normal in this case, the decrease in luminance due to the aberration of the detection optical path can be excluded from the abnormality cause, and the abnormality cause can be narrowed down to the decrease in sensitivity of the detection optical path other than the detector. As described above, it is possible to more accurately identify the abnormality cause in a case where the determination result for the measurement result of the detection sensitivity is abnormal. The determination unit 14 determines whether the measurement results of the detection sensitivity using the plurality of respective detection channels are normal or abnormal.

### Modification 2 of Second and Third Embodiments

The optical microscope 1 according to each of the second and third embodiments may further include an irradiation density measurement unit that measures the irradiation density of the specimen surface on the basis of the measurement result (excitation output) in the excitation output measurement unit 16 and the measurement result (imaging performance) in the imaging performance measurement unit 12.

Specifically, the irradiation density measurement unit calculates the irradiation density by using Formula (1).

$$Irradiation density = excitation output / imaging area \qquad Formula ( 1 )$$

The excitation output used in Formula (1) is an objective lens emission output. In a case where the measurement result in the excitation output measurement unit 16 is not the objective lens emission output, the objective lens emission output may be calculated by multiplying the measurement result in the excitation output measurement unit 16 by the transmittance of the optical system from the measurement position to the specimen surface. The imaging area used in Formula (1) is calculated on the basis of the PSF or the LSF that is the measurement result in the imaging performance measurement unit 12. The calculated value of the irradiation density according to Formula (1) may be a relative value (no unit) or an absolute value (W/mm²).

The storage unit 13 may further store an irradiation density threshold for determining normality (OK) or abnormality (NG) of the measurement result of the irradiation density. Furthermore, the storage unit 13 may further store an abnormality cause corresponding to a combination of a determination result for the measurement result of the irradiation density and a determination result for another measurement result. Specifically, in Modification 2 of the second embodiment, the storage unit 13 may further store an abnormality cause corresponding to a combination of a determination result for the measurement result of the imaging performance and/or a determination result for the measurement result of the excitation output and a determination result for the measurement result of the irradiation density. In Modification 2 of the third embodiment, the storage unit 13 may further store an abnormality cause corresponding to a combination of one or more of the determination result for the measurement result of the imaging performance, the determination result for the measurement result of the detection sensitivity, and the determination result for the measurement result of the excitation output, and the determination result for the measurement result of the irradiation density.

The determination unit 14 may further compare the measurement result of the irradiation density with the irradiation density threshold stored in the storage unit 13, and determine whether the measurement result of the irradiation density is normal or abnormal on the basis of the comparison result. The determination result may be output to the display unit 15, and the display unit 15 may display the determination result.

In addition, the determination unit 14 may select a corresponding abnormality cause from among the abnormality causes stored in the storage unit 13 on the basis of the determination result for the measurement result of the irradiation density and the determination result for another measurement result. Specifically, in Modification 2 of the second embodiment, the determination unit 14 may select the abnormality cause on the basis of the determination result for the measurement result of the imaging performance and/or the determination result for the measurement result of the excitation output, and the determination result for the measurement result of the irradiation density. In Modification 2 of the third embodiment, the determination unit 14 may select the abnormality cause on the basis of one or more of the determination result for the measurement result of the imaging performance, the determination result for the measurement result of the detection sensitivity, and the determination result for the measurement result of the excitation output, and the determination result for the measurement result of the irradiation density. The determination unit 14 may output the selected abnormality cause to the display unit 15, and output the countermeasure to be taken by a user of the optical microscope 1 to the display unit 15 on the basis of the selected abnormality cause.

Since the irradiation density has a high correlation with a change in fluorescence intensity accompanying a change in imaging performance, it is possible to determine normality or abnormality with higher accuracy with respect to the change in fluorescence intensity.

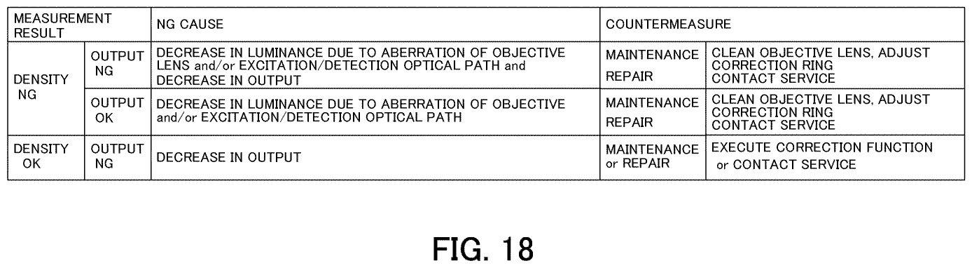

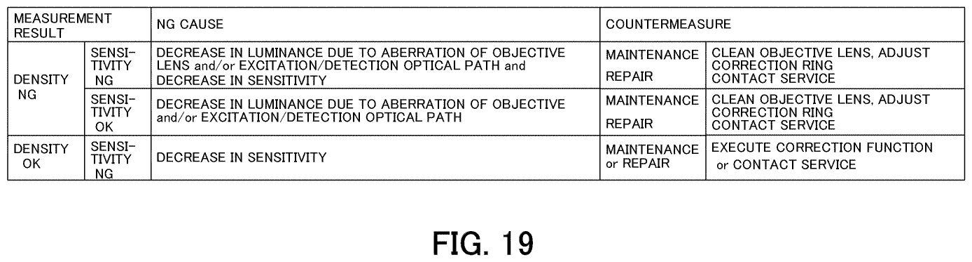

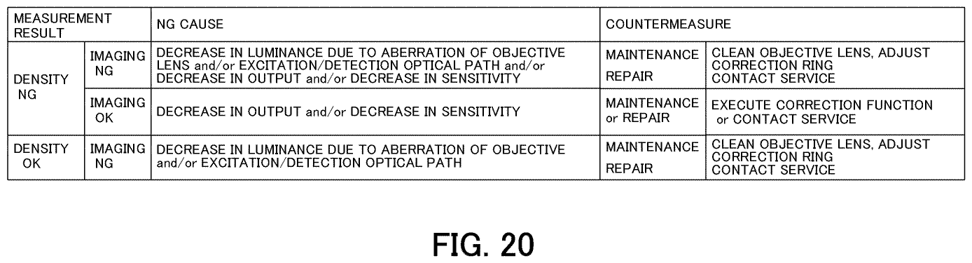

FIG. 18 is a diagram exemplifying a determination result for each measurement result of the irradiation density and the excitation output, an abnormality cause (NG cause) selected on the basis of the determination result, and a countermeasure against the abnormality cause according to Modification 2 of the second or third embodiment. FIG. 19 is a diagram exemplifying a determination result for each measurement result of the irradiation density and the detection sensitivity, an abnormality cause (NG cause) selected on the basis of the determination result, and a countermeasure against the abnormality cause according to Modification 2 of the third embodiment. FIG. 20 is a diagram exemplifying a determination result for each measurement result of the irradiation density and the imaging performance, an abnormality cause (NG cause) selected on the basis of the determination result, and a countermeasure against the abnormality cause according to Modification 2 of the second or third embodiment. As exemplified in FIGS. 18 to 20, it is possible to select an abnormality cause and present a countermeasure against the abnormality cause from the determination results for the two measurement results including the irradiation density.

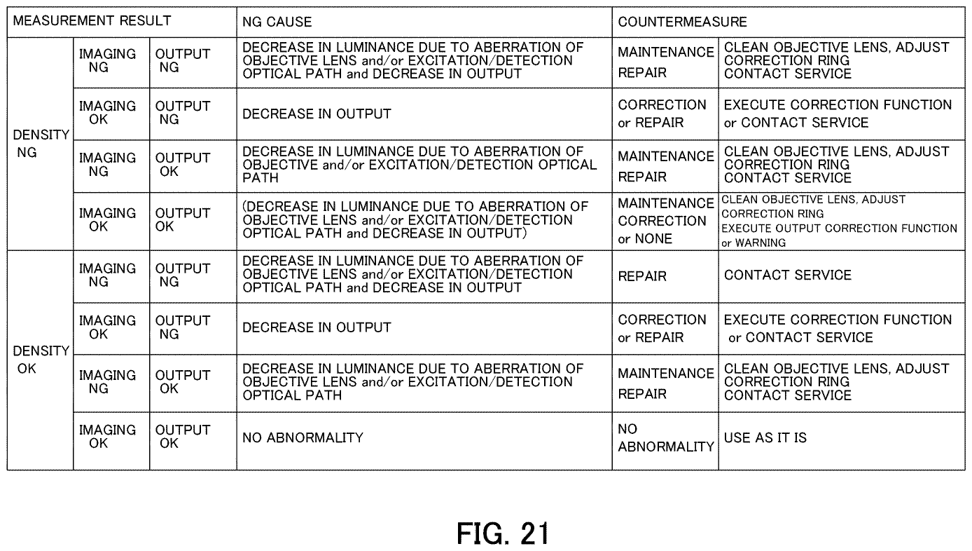

FIG. 21 is a diagram exemplifying a determination result for each measurement result of the irradiation density, the imaging performance, and the excitation output, an abnormality cause (NG cause) selected on the basis of the determination result, and a countermeasure against the abnormality cause according to Modification 2 of the second or third embodiment. As exemplified in FIG. 21, it is possible to select an abnormality cause and present a countermeasure against the abnormality cause from the determination results for the three measurement results including the irradiation density and the imaging performance. In addition, in the example shown in FIG. 21, in a case where the determination result for each of the measurement results of the imaging performance and the excitation output is normal (imaging OK, output OK), but the determination result for the measurement result of the irradiation density is abnormal (density NG), it is considered that the imaging performance and the excitation output have not yet been determined to be abnormal, but the irradiation density starts to be affected. Therefore, in this case, as a countermeasure, it is possible to warn that there is a sign of deterioration in imaging performance and excitation output, and it is possible to further improve the accuracy of the countermeasure.

### Modification 3 of Second and Third Embodiments

In the second and third embodiments, in addition to the measurement of the excitation output, the excitation output may be measured by using each of the plurality of light sources, and the measurement result of the excitation output using each of the plurality of light sources may be used to identify the abnormality cause in a case where the determination result for the measurement result of the excitation output is abnormal. For example, in a case where the determination result for the measurement result of the excitation output is abnormal, the decrease in the light source output and/or the decrease in the transmittance of the excitation optical path are identified as the abnormality cause. In a case where the determination results for the measurement results of the excitation output using the plurality of respective light sources are all also abnormal, the abnormality cause can be narrowed down to the decrease in the transmittance of the excitation optical path. As described above, it is possible to more accurately identify the abnormality cause in a case where the determination result for the measurement result of the excitation output is abnormal. The determination unit 14 determines whether each of the measurement results of the excitation output using the plurality of respective light sources is normal or abnormal.

### Hardware Configuration of Arithmetic Device 3

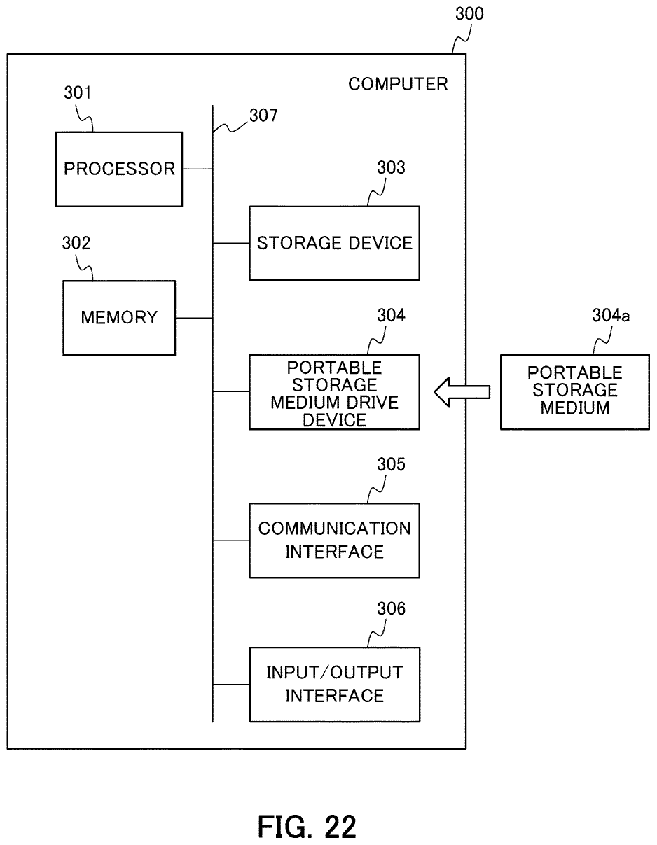

The arithmetic device 3 may be realized by a computer 300 exemplified in FIG. 22. FIG. 22 is a diagram exemplifying a hardware configuration of the computer 300.

The computer 300 exemplified in FIG. 22 includes a processor 301, a memory 302, a storage device 303, a portable storage medium drive device 304, a communication interface 305, and an input/output interface 306, and these devices are connected to a bus 307 and can transmit and receive data to and from each other. These constituents are hardware.

The processor 301 may be, for example, a single processor, a multiprocessor, or a multi-core processor. The processor 301 performs various types of processing (for example, the processing exemplified in FIG. 7) by executing programs such as an operating system (OS) and an application.

The memory 302 includes a random access memory (RAM) and a read only memory (ROM). A part of the program or the like executed by the processor 301 is temporarily stored in the RAM. Furthermore, the RAM is also used as a working storage area of the processor 301. The ROM stores the program executed by the processor 301 and various types of data necessary for executing the program.

The storage device 303 is a device that stores data, and is a hard disk drive (HDD), a solid state drive (SSD), or the like.

The portable storage medium drive device 304 drives a portable storage medium 304a, accesses the contents stored therein, and reads and writes data. Examples of the portable storage medium 304a include a memory device, a flexible disk, an optical disk, and a magneto-optical disk. Other examples of the portable storage medium 304a include a compact disc read only memory (CD-ROM), a digital versatile disc (DVD), a Blu-ray Disc, a universal serial bus (USB) memory, and an SD memory card.

The communication interface 305 is connected to a communication network in a wired or wireless manner, and communicates with an external device connected to the communication network.

The input/output interface 306 is connected to an external device and inputs/outputs data to/from the external device. External devices connected to the input/output interface 306 are, for example, the microscope body 2 and the display device 4, and an input device may be further connected thereto. Examples of the input device include a keyboard, a mouse, a joystick, and a touch panel.

In this computer 300, the program executed by the processor 301 and various types of data necessary for executing the program may be stored not only in the memory 302, but also in the storage device 303 or the portable storage medium 304a. Furthermore, the program executed by the processor 301 and various types of data necessary for executing the program may be stored in the storage device 303 or the portable storage medium 304a via the communication interface 305 from an external device connected to a network. The memory 302, the storage device 303, and the portable storage medium 304a are non-transitory computer-readable recording media.

Furthermore, the computer 300 is not limited to the computer exemplified in FIG. 22, and may include a plurality of some constituents among the constituents exemplified in FIG. 22 or do not include some constituents among the constituents exemplified in FIG. 22.

In addition, the computer 300 may also include hardware such as a microprocessor, a DSP, an application specific integrated circuit (ASIC), a programmable logic device (PLD), and a field-programmable gate array (FPGA). For example, the processor 301 may be implemented by using at least one of these pieces of hardware.

In a case where the arithmetic device 3 is realized by the computer 300 exemplified in FIG. 22, the processor 301 operates as a part of the imaging performance measurement unit 12, the determination unit 14, and the irradiation density measurement unit. In addition, one or more of the memory 302, the storage device 303, and the portable storage medium 304a operate as the storage unit 13.

Although the embodiments of the invention have been described above, the invention is not limited to the above-described embodiments, and various improvements and modifications can be made without departing from the gist of the invention.

What is claimed is:

1. An optical microscope comprising:
an objective lens;
a light source configured to output excitation light;
an excitation output measurement device configured to measure an excitation output; and
a processor configured to measure imaging performance and determine performance of the optical microscope on the basis of a measurement result of the imaging performance and a measurement result of the excitation output.

2. The optical microscope according to claim 1, further comprising
a memory configured to store thresholds for determining whether the measurement results are normal or abnormal, wherein
the processor compares the measurement results with the thresholds stored in the memory, and determines whether the measurement results are normal or abnormal.

3. The optical microscope according to claim 2, wherein
the memory further stores an abnormality cause corresponding to a combination of a determination result for the measurement result of the imaging performance and a determination result for the measurement result of the excitation output, and
the processor selects the abnormality cause on the basis of the determination result for the measurement result of the imaging performance and the determination result for the measurement result of the excitation output.

4. The optical microscope according to claim 3, wherein
the processor outputs a countermeasure to be taken by a user of the optical microscope on the basis of the selected abnormality cause.

5. The optical microscope according to claim 4, wherein
when the determination result for the measurement result of the imaging performance is abnormal, the processor outputs a countermeasure that gives priority to coping with the imaging performance as the countermeasure.

6. The optical microscope according to claim 1, wherein
the processor measures an irradiation density by calculating the irradiation density on the basis of the measurement result of the imaging performance and the measurement result of the excitation output.

7. The optical microscope according to claim 6, further comprising
a memory configured to store thresholds for determining whether the measurement results are normal or abnormal, wherein
the processor compares the measurement results with the thresholds stored in the memory, and determines whether the measurement results are normal or abnormal.

8. The optical microscope according to claim 7, wherein
the memory further stores an abnormality cause corresponding to a combination of a determination result for the measurement result of the imaging performance and/or a determination result for the measurement result of the excitation output and a determination result for the measurement result of the irradiation density, and
the processor selects the abnormality cause on the basis of the determination result for the measurement result of the imaging performance and/or the determination result for the measurement result of the excitation output and the determination result for the measurement result of the irradiation density.

9. An optical microscope comprising:
an objective lens;
a detector configured to detect light from a specimen;
a detection sensitivity measurement device configured to measure detection sensitivity; and
a processor configured to measure imaging performance and determines performance of the optical microscope on the basis of a measurement result of the imaging performance and a measurement result of the detection sensitivity.

10. The optical microscope according to claim 9, further comprising
a memory configured to store thresholds for determining whether the measurement results are abnormal or abnormal, wherein
the processor compares the measurement results with the thresholds stored in the memory, and determines whether the measurement results are normal or abnormal.

11. The optical microscope according to claim 10, wherein
the memory further stores an abnormality cause corresponding to a combination of a determination result for the measurement result of the imaging performance and a determination result for the measurement result of the detection sensitivity, and
the processor selects the abnormality cause on the basis of the determination result for the measurement result of the imaging performance and the determination result for the measurement result of the detection sensitivity.

12. The optical microscope according to claim 11, wherein
the processor outputs a countermeasure to be taken by a user of the optical microscope on the basis of the selected abnormality cause.

13. The optical microscope according to claim 12, wherein
when the determination result for the measurement result of the imaging performance is abnormal, the processor outputs a countermeasure that gives priority to coping with the imaging performance as the countermeasure.

14. The optical microscope according to claim 9, further comprising:
a light source configured to output excitation light; and
an excitation output measurement device configured to measure an excitation output, wherein the processor determines the performance of the optical microscope on the basis of the measurement result of the imaging performance, the measurement result of the detection sensitivity, and a measurement result of the excitation output.

15. The optical microscope according to claim 14, further comprising
a memory configured to store thresholds for determining whether the measurement results are normal or abnormal, wherein
the processor compares the measurement results with the thresholds stored in the memory, and determines whether the measurement results are abnormal or abnormal.

16. The optical microscope according to claim 15, wherein
the memory further stores an abnormality cause corresponding to a combination of a determination result for the measurement result of the imaging performance, a determination result for the measurement result of the detection sensitivity, and a determination result for the measurement result of the excitation output, and
the processor selects the abnormality cause on the basis of the determination result for the measurement result of the imaging performance, the determination result for the measurement result of the detection sensitivity, and the determination result for the measurement result of the excitation output.

17. The optical microscope according to claim 16, wherein
the processor outputs a countermeasure to be taken by a user of the optical microscope on the basis of the selected abnormality cause.

18. The optical microscope according to claim 17, wherein
when the determination result for the measurement result of the imaging performance is abnormal, the processor outputs a countermeasure that gives priority to coping with the imaging performance as the countermeasure.

19. The optical microscope according to claim 14, wherein
the processor measures an irradiation density by calculating the irradiation density on the basis of the measurement result of the imaging performance and the measurement result of the excitation output.

20. The optical microscope according to claim 19, further comprising
a memory configured to store thresholds for determining whether the measurement results are abnormal or abnormal, wherein
the processor compares the measurement results with the thresholds stored in the memory, and determines whether the measurement results are abnormal or abnormal.

21. The optical microscope according to claim 20, wherein
the memory further stores an abnormality cause corresponding to a combination of a determination result for the measurement result of the irradiation density and one or more of a determination result for the measurement result of the imaging performance, a determination result for the measurement result of the detection sensitivity, and a determination result for the measurement result of the excitation output, and
the processor selects the abnormality cause on the basis of the determination result for the measurement result of the irradiation density and the one or more of the determination result for the measurement result of the imaging performance, the determination result for the measurement result of the detection sensitivity, and the determination result for the measurement result of the excitation output.

22. The optical microscope according to claim 1, wherein
the optical microscope is a laser scanning fluorescence microscope.

23. The optical microscope according to claim 3, further comprising
a display device configured to display one or more of the measurement results, the determination results, and the abnormality cause.

24. The optical microscope according to claim 9, wherein
the optical microscope is a confocal microscope, and
further measures a deviation amount of an incident optical axis to a confocal pinhole.

25. The optical microscope according to claim 1, wherein
the processor measures the imaging performance by using each of a plurality of objective lenses, and determines whether each of measurement results of the imaging performance using the plurality of respective objective lenses is normal or abnormal.

26. The optical microscope according to claim 9, wherein
the processor measures the imaging performance by using each of a plurality of objective lenses, and determines whether each of measurement results of the imaging performance using the plurality of respective objective lenses is normal or abnormal.

27. The optical microscope according to claim 9, wherein
the detection sensitivity measurement device measures the detection sensitivity by using each of a plurality of detectors, and
the processor determines whether each of measurement results of the detection sensitivity using the plurality of respective detectors is normal or abnormal.

28. The optical microscope according to claim 1, wherein
the excitation output measurement device measures the excitation output by using each of a plurality of light sources, and
the processor determines whether each of measurement results of the excitation output using the plurality of respective light sources is normal or abnormal.

29. The optical microscope according to claim 14, wherein
the excitation output measurement device measures the excitation output by using each of a plurality of light sources, and
the processor determines whether each of measurement results of the excitation output using the plurality of respective light sources is normal or abnormal.

30. The optical microscope according to claim 8, wherein
the processor outputs a countermeasure to be taken by a user of the optical microscope on the basis of the selected abnormality cause.

31. The optical microscope according to claim 21, wherein
the processor outputs a countermeasure to be taken by a user of the optical microscope on the basis of the selected abnormality cause.

32. The optical microscope according to claim 4, wherein
the processor outputs, as the countermeasure, a countermeasure by execution of a correction function, correction, or maintenance/repair.

33. The optical microscope according to claim 12, wherein
the processor outputs, as the countermeasure, a countermeasure by execution of a correction function, correction, or maintenance/repair.

34. The optical microscope according to claim 1, wherein
the excitation output measurement device includes an intensity monitor configured to measure an intensity of excitation light, and
the intensity monitor is provided
on an optical path closer to the light source side than the objective lens,
in a vicinity of a focal plane of the objective lens, or
on an optical path on an opposite side to the objective lens with a focal plane of the objective lens interposed therebetween.

35. The optical microscope according to claim 9, wherein
the detection sensitivity measurement device includes
a reflection element or a phosphor provided on an optical path closer to a light source side than the objective lens,
a reference specimen or a reference light source disposed in a vicinity of a focal position of the objective lens, or
a light source provided on an opposite side to the objective lens with the focal position of the objective lens interposed therebetween.

36. The optical microscope according to claim 1, wherein
the processor acquires an image of a reference specimen disposed at a focal position of the objective lens, and calculates a point spread function on the basis of the image.

37. The optical microscope according to claim 9, wherein
the processor acquires an image of a reference specimen disposed at a focal position of the objective lens, and calculates a point spread function on the basis of the image.

38. The optical microscope according to claim 1, wherein
the processor measures a wavefront of excitation light in a focal plane of the objective lens, and calculates a point spread function on the basis of the measured wavefront.

39. The optical microscope according to claim 9, wherein
the processor measures a wavefront of excitation light in a focal plane of the objective lens, and calculates a point spread function on the basis of the measured wavefront.

40. The optical microscope according to claim 1, wherein
the processor acquires an image of an edge specimen disposed at a focal position of the objective lens, and calculates a line spread function on the basis of the image.

41. The optical microscope according to claim 9, wherein
the processor acquires an image of an edge specimen disposed at a focal position of the objective lens, and calculates a line spread function on the basis of the image.

42. The optical microscope according to claim 40, wherein
the edge specimen is a chart specimen having a radial pattern having edges in eight or more directions at an entire circumference of 360°.

43. A performance determination method of determining performance of an optical microscope, comprising:
measuring an excitation output;
measuring imaging performance; and
determining the performance of the optical microscope on the basis of a measurement result of the excitation output and a measurement result of the imaging performance.

44. A performance determination method of determining performance of an optical microscope, comprising:
measuring detection sensitivity of a detector configured to detect light from a specimen;
measuring imaging performance; and
determining the performance of the optical microscope on the basis of a measurement result of the detection sensitivity and a measurement result of the imaging performance.

45. The performance determination method according to claim 44, further comprising
measuring an excitation output, wherein
determining the performance of the optical microscope includes determining the performance of the optical microscope on the basis of a measurement result of the excitation output, the measurement result of the detection sensitivity, and the measurement result of the imaging performance.
